(19) United States
(12) Patent Application Publication
(10) Pub. No.: US 2002/0066325 A1
(43) Pub. Date: Jun. 6, 2002

(54) Twin screw spur gear drive

(76) Inventors: Andreas Roither, Enger (DE); Ralf Bokamper, Lubbecke (DE)

Correspondence Address: HENRY M FEIEREISEN, 350 FIFTH AVENUE, SUITE 3220, NEW YORK, NY, 10118, US

(21) Appl. No.: 09/989,679

(22) Filed: Nov. 20, 2001

Related U.S. Application Data
(63) Continuation of application No. PCT/EP01/02886, filed on Mar. 15, 2001.

(30) Foreign Application Priority Data
Mar. 20, 2000 (DE) 200 05 065.6

(51) Int. Cl. F16H 25/20

(52) U.S. Cl. 74/89.23; 74/89.27; 74/425

(57) ABSTRACT

A twin screw spur gear drive in the form of an electromotive linear drive, useful for furniture in the field of hospital and nursing care, includes a housing for attachment of a flanged tube, and a screw drive having at least two spur wheels and a screw, which is wedged onto a journal of an electric motor and engaging the spur wheels, for operating a spindle. A drive nut is placed in threaded engagement with the spindle and secured against rotation. The drive nut carries a lifting tube which is connected to a component to be operated and moves back and forth as the spindle rotates and the nut is advanced along the spindle. In order to protect the twin screw drive from ingress of contaminants such as cleaning liquid, seals are provided for sealing at least some of the abutting surfaces between the housing and adjoining components.

### CROSS-REFERENCES TO RELATED APPLICATIONS

This application is a continuation of prior filed copending PCT International application no. PCT/EP01/02886, filed Mar. 15, 2001.

This application claims the priority of German Patent Application Serial No. 200 05065.6, filed Mar. 20, 2000, the subject matter of which is incorporated herein by reference.

### BACKGROUND OF THE INVENTION

The present invention relates, in general, to a twin-screw spur gear drive in the form of an electromotive linear drive, useful, for example, for furniture in the field of hospital and nursing care.

A conventional twin-screw spur gear drive of this type includes a housing for accommodating a screw spur gear drive having a screw, which is mounted on a journal of an electric motor and engaging at least two spur gears, and a rotatable spindle which supports a drive nut which represents an output member and is secured against rotation. The drive nut carries a lifting tube for adjusting an attached object, and is arranged together with the lifting tube inside a flange tube which is mounted to the housing. The screw drive is implemented by a step-down gear mechanism to reduce the speed of the motor, and operates the spindle, whereby the motor shaft may extend perpendicular to the spindle. The linear speed by which the lifting tube moves in and out is fairly small compared to the motor speed.

The use of a motorized bed in a hospital or in a nursing home requires cleaning and disinfecting of the twin screw drive periodically or when changing patients. Cleaning and disinfection normally is implemented in washing installation. Thus, internal components of the twin screw drive must be protected from ingress of cleaning liquid.

It would therefore be desirable and advantageous to provide a twin screw drive which is so configured as to allow cleaning and disinfecting with a respective cleaning liquid, without encountering problems.

### SUMMARY OF THE INVENTION

According to one aspect of the present invention, a twin screw spur gear drive includes a housing; a flanged tube fixedly secured to the housing; a screw drive having at least two spur wheels and a screw, which is wedged onto a journal of an electric motor and engages the spur wheels; a rotatable threaded spindle; a drive nut placed in threaded engagement with the spindle and secured against rotation; a lifting tube secured to the drive nut and moving back and forth; and sealing elements for sealing at least some of abutting surfaces between the housing and adjoining components against ingress of contaminants such as cleaning or disinfecting liquid.

The use of sealing elements results in a protection of at least those components disposed inside the housing. The configuration of the sealing elements can be suited to the abutting surface to be sealed. There are innumerable types of sealing elements conceivable, only several of which will be detailed here. Examples include all those sealing elements that are commercially available and preferred here for economical reasons, e.g. toroidal sealing rings, flat sealing rings, and the like. According to the present invention, the abutting surface between the housing and the flanged tube may be sealed by an O-ring or by a toroidal sealing ring. Suitably, the flanged tube is provided with a guide cap at its housing distal side for sliding contact of the lifting tube, whereby sealing is realized by a packing of formed seal which is inserted in the guide cap. Sealing of the guide cap against the lifting tube can also be effected by a toroidal sealing ring or O-ring.

In order to support the lifting tube when moving out, a gas spring or damper may be provided in parallel spaced-apart relationship to the spindle. As the lifting tube moves in, the gas spring serves then as damper. The gas spring accommodates a piston rod which can move in and out and is sealed against the guide cap in the flanged tube also by a toroidal sealing ring or O-ring. The piston rod may be connected by a coupling element to the fork head of the lifting tube so that the in-and-out movement of the fork head is in synchronism with the piston rod of the gas spring or damper.

According to another feature of the present invention, an attachment piece, e.g., a fork head, is secured to the free end of the lifting tube. The attachment piece may have a cylindrical protrusion for threaded engagement in the lifting tube. Sealing may suitably be effected by a flat sealing ring or a sealing disk. At its side opposite to the flanged tube, the housing may have a connection, e.g., a fork head, which is connected to the housing by a plate. Also in this case, the sealing may be implemented by a flat sealing ring.

The gear is so configured as to allow placement of the drive motor, whereby the sealing may also be realized by a flat sealing ring. In particular, when used in the medical field or in the nursing field, it may be necessary to lower the motor-driven component at a speed which is higher than the normal lowering speed at running drive motor. Thus, in accordance with the present invention, the drive train from the drive motor to the spindle is so configured as to allow a disengagement and engagement at a suitable location, for example, through disengagement of two components that normally are in engagement during operation. Disengagement may be realized, for example, by a handle or crank routed to the outside through a suitable hole in the housing. In the event, the twin screw drive is fabricated without a disengagement mechanism, the hole is closed by a plug or bolt.

The housing may be further provided with an opening for receiving a cable gland to allow passage of a power cable. The cable gland is suitably sealed by a rubber gasket.

Suitably, the end positions of the drive nut are limited for safety reasons. This can be implemented by placing a perforated rail in a grooved, outwardly directed extension of the flanged tube for arrangement of limit switches at the respective end zones. The tappets of the limit switches are actuated as the drive nut reaches predetermined positions to shutdown the electric motor.

In the event the twin screw drive has incorporated therein a disengagement mechanism, the axially shiftable interlocking coupling disks are formed at confronting surfaces with rectangular teeth to ensure that forces can be transferred in both rotation directions. Advantageously, the twin screw drives involved here may have a mechanism to register and detect the path as traveled by the drive nut. An example includes the counting of impulses generated during rotation of the spindle. Another example includes the use of a linear potentiometer in parallel disposition to the flange guide to register the advance of the drive nut.

According to another feature of the present invention, which is needed in particular when utilizing the twin screw drive in the field of hospitals or nursing care, operation of the screw drive should be maintained, even when encountering a power outage. At such emergency situations, the screw drive may be equipped with a secondary power source, e.g., a battery or accumulator. Since, however, power outages are rare occasions, it is preferred for reasons of simplicity, to provide a manual actuating mechanism, e.g., a crank, for operating the screw drive. This manual actuating mechanism may be implemented by forming a rectangular opening in one of the worm wheels for engagement by the crank.

Drive motors used for twin screw drives according to the invention may include d.c. motors, running at a safety d.c. voltage of about 12 to 36 volts. Examples of d.c. motors include a brushless d.c. motor which cannot be shorted, or a self-locking fan motor.

### BRIEF DESCRIPTION OF THE DRAWING

Other features and advantages of the present invention will be more readily apparent upon reading the following description of a preferred exemplified embodiment of the invention with reference to the accompanying drawing, in which

FIG. 1 shows an exploded illustration of a twin screw drive according to the present invention.

### DETAILED DESCRIPTION OF PREFERRED EMBODIMENTS

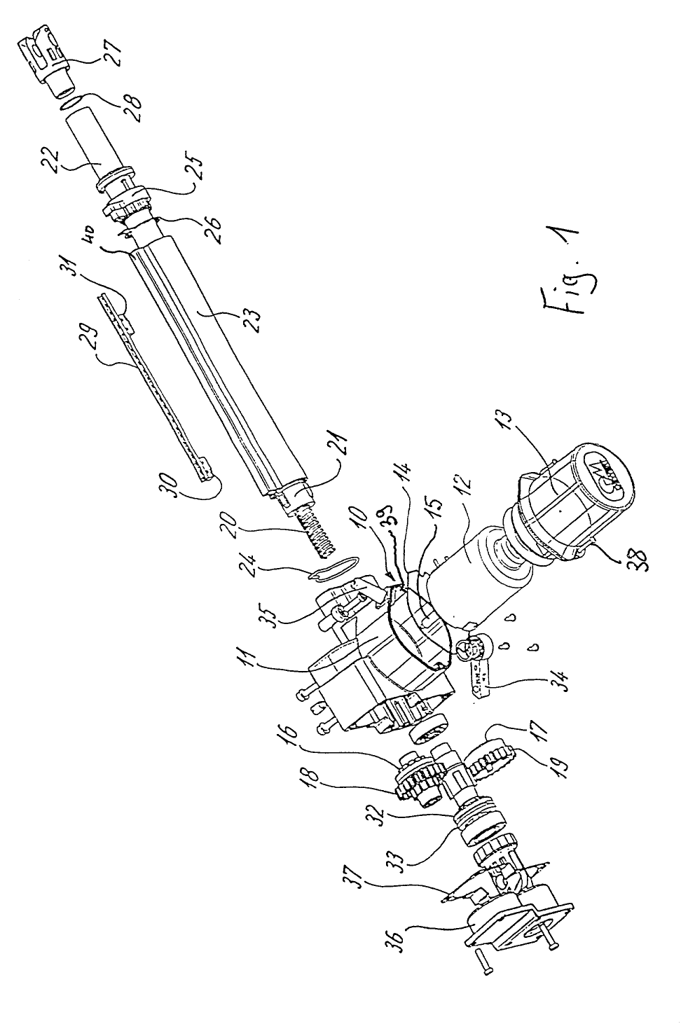

Turning now to FIG. 1, there is shown an exploded illustration of a twin screw drive according to the present invention, generally designated by reference numeral 10. The twin screw drive is a single drive having a housing 11 which may be made of plastics through a diecasting process, or may be made of steel or aluminum. Disposed in the housing 11 is a drive motor 12, e.g. a d.c. motor, running at a safety d.c. voltage of about 12 to 36 volts. Examples of d.c. motors include a brushless d.c. motor which cannot be shorted, or a self-locking fan motor. The motor 12 has one motor portion that slightly projects out of the housing 11. A cap 13 is placed of this motor portion of the drive motor 12 and bolted together with a confronting end surface of the housing 11 by screw fasteners 38 engageable in complementary anchoring grooves 39 in the housing 11. A seal 14 is placed between the end face of the housing 11 and the cap 13 to prevent ingress of contaminants, e.g. cleaning liquid. The seal 14 is suitably a flat sealing ring.

The drive motor 12 has a journal 15 which is in fixed rotative engagement with a worm, not shown, inside the housing 11. Of course, the journal 15 may be so configured as to form itself the worm. The worm is in threaded engagement with two worm wheels 16, 17 which are placed in offset relationship at an angle of 180° to thereby prevent bending stress on the journal 15. In the non-limiting example shown here, the worm wheel 16, 17 have spur gears 18, 19. The worm drive comprised of motor 12 and, not shown, worm is used to drive a threaded spindle 20. Placed on the spindle 20 is a drive nut 21 which is so mounted as to travel in a linear movement along the spindle 20 while being secured against rotation. The drive nut 21 is securely fixed to a lifting tube 22 which is arranged inside an outer flanged tube 23 and moveable in and out relative thereto as the spindle 20 rotates in one or the other rotation direction. The flanged tube 23 is securely attached to the housing 11 and sealed against the housing 11 by a suitably configured flat sealing ring 24.

A guide cap 25 is securely mounted to the free housing-distal end of the flanged tube 23 and sealed against the flanged tube 23 by a seal 26. The free end of the lifting tube 22 carries an attachment, e.g., in the form of a fork head 27, which is sealed against the lifting tube 22 by a sealing disk 28. The flanged tube 23 is formed with a groove-like extension 40 for receiving a perforated rail 29 which is provided with two limit switches 30, 31 to limit both end positions of the drive nut 21. The lifting tube 22, the flanged tube 23 and the fork head 29 as well as the cap 13 may be made of plastics.

Although not shown in detail, the twin screw drive 10 may be provided with a detection mechanism to register the path as traveled by the drive nut 21 and thus of the lifting tube 22 during rotation of the spindle 20. The detection mechanism may be configured to count electric impulses as the spindle 20 turns, whereby each revolution of the spindle triggers one impulse. Of course other mechanisms may be used as well to register the traveled path by the drive nut, e.g. the use of a linear potentiometer arranged in parallel disposition to the flange guide.

The flanged tube 23 may accommodate a gas spring or a hydraulic damper, not shown, to support the lifting tube 22 when moving out. The gas spring accommodates a piston rod, not shown, which can move in and out and is linked to the fork head 27 or the lifting tube 22. In this way, a greater force can be applied upon the attached component. The gas spring provides also a damping function, when the lifting tube 22 retracts.

Positioned next to the worm wheels 16, 17 on the side facing away from the flange tube 23 are two coupling disks 32, 33 which have teeth at their confronting end surfaces for interlocking engagement. At least one of the coupling disks 32, 33 is supported for movement in axial direction to thereby separate the teeth of the coupling disks 32, 33 from one another and thereby implement a disengagement of the twin screw drive 10. Suitably, the teeth are configured as rectangular teeth so as to transfer forces or torques in both rotation directions. Disengagement of the coupling disks 32, 33 is initiated by actuating a rotary lever 34 which is supported by the housing 11. Connected to the outer free end of the lever 34 may be a, not shown, flexible pull member to pivot the lever 34. Suitably, the pull member may be a Bowden cable.

The housing 11 is further provided with a connection 35 for a power cable, not shown. The connection 35 may be a cable gland to provide stress relief for the power cable. A cover 36 closes the housing 11 at its end distal to the flanged tube 23, whereby a seal 37 is provided to seal the cover 36 against the housing 11.

While the invention has been illustrated and described as embodied in a twin screw spur gear drive, it is not intended to be limited to the details shown since various modifications and structural changes may be made without departing in any way from the spirit of the present invention.

What is claimed as new and desired to be protected by Letters Patent is set forth in the appended claims:

What is claimed is:

1. A twin screw spur gear drive in the form of an electromotive linear drive, useful for furniture in the field of hospital and nursing care, comprising:
a housing;
a flanged tube fixedly secured to the housing;
a worm drive having at least two spur wheels and a worm, which is wedged onto a journal of an electric motor and engaging the spur wheels;
a rotating threaded spindle;
a drive nut representing an output element, wherein the drive nut is placed in threaded engagement with the spindle and secured against rotation;
a lifting tube secured to the drive nut and moving back and forth in unison with the drive nut as the spindle rotates; and
sealing means for sealing at least some of abutting surfaces between the housing and adjoining components against ingress of contaminants.

2. The drive of claim 1, wherein the sealing means includes a seal selected from the group consisting of toroidal sealing ring and O ring, for sealing the flanged tube against the housing.

3. The drive of claim 1, wherein the flanged tube has a free end, and further comprising a guide cap securely fixed into the free end of the flanged tube, wherein the sealing means includes a seal for sealing the guide cap against the flanged pipe.

4. The drive of claim 3, wherein the seal is a flat sealing ring.

5. The drive of claim 3, and further comprising a member selected from the group consisting of gas spring and hydraulic damper, wherein the member is inserted into the flanged tube in axis-parallel relationship to the threaded spindle and has a piston rod for connection to the lifting tube, wherein the sealing means includes a toroidal sealing ring disposed in the guide cap for sealing the piston rod.

6. The drive of claim 5, and further comprising a fork head mounted onto the lifting tube, wherein the piston rod of the member is connected to the lifting tube via the fork head.

7. The drive of claim 6, wherein the sealing means includes a seal selected from the group consisting of sealing disk and flat sealing ring, wherein the seal seals the fork head against the lifting tube.

8. The drive of claim 1, and further comprising a mechanism for allowing disengagement of the twin screw spur gear drive, and a rotary handle mounted to the housing for manual actuation, wherein the sealing means includes a seal selected from the group consisting of O-ring and toroidal sealing ring for sealing the housing against the handle.

9. The drive of claim 8, and further comprising a sealing bolt intended for threaded engagement in an aperture of the housing, and an actuator for insertion in the aperture of the housing, when the sealing bolt is detached, for manual operation of the twin screw spur gear drive.

10. The drive of claim 9, wherein the actuator is a crank.

11. The drive of claim 1, wherein the housing has an opening receiving a cable gland for threaded attachment of a power cable.

12. The drive of claim 1, and further comprising two coupling disks arranged in a power train between the electric motor and the treaded spindle, wherein at least one of the coupling disks is movable in an axial direction, wherein confronting end surfaces of the coupling disks have interlocking teeth.

13. The drive of claim 12, wherein the teeth are rectangular teeth for a power transfer in both directions of rotation.

14. The drive of claim 1, wherein the flanged tube has a grooved extension for insertion of a perforated rail, and further comprising limit switches for attachment in the perforated rail to limit end positions of the threaded spindle.

15. The drive of claim 1, wherein the electric motor is one of a brushless d.c. motor and fan motor.

16. The drive of claim 1, and further comprising a linear potentiometer for attachment to a guidance for the flanged tube.
